(19) United States
(12) Patent Application Publication
(10) Pub. No.: US 2008/0259227 A1
(43) Pub. Date: Oct. 23, 2008

(54) Small switch having liquid crystal display

(75) Inventors: Kenichi Hirose, Kawasaki-shi (JP); Kazumitsu Onuki, Kawasaki-shi (JP); Toyonaru Tanaka, Kawasaki-shi (JP)

Correspondence Address: BACON & THOMAS, PLLC, 625 SLATERS LANE, FOURTH FLOOR, ALEXANDRIA, VA, 22314-1176, US

(73) Assignee: NIHON KAIHEIKI INDUSTRIAL COMPANY, LTD., Kawasaki-shi (JP)

(21) Appl. No.: 11/889,631

(22) Filed: Aug. 15, 2007

Related U.S. Application Data
(62) Division of application No. 10/943,995, filed on Sep. 20, 2004.

(30) Foreign Application Priority Data
Jan. 29, 2004 (JP) 2004-021833
Jan. 29, 2004 (JP) 2004-021834
Jul. 7, 2004 (JP) 2004-200772

(51) Int. Cl. G02F 1/1333

(52) U.S. Cl. 349/1

(57) ABSTRACT

A small switch having a liquid crystal display includes an operation button; a liquid crystal display device having a liquid crystal panel for displaying information including characters and/or pictures on the operation button and a printed circuit board on which an IC chip, which serves as a driver circuit for the liquid crystal panel, is mounted, the liquid crystal display device being housed in the operation button; a switch body including a contact mechanism for opening and closing an electrical path by vertically moving the operation button; and backlight sources having different colors. The liquid crystal panel is an antiferroelectric liquid crystal panel. The backlight sources are sequentially turned on at high speed below the antiferroelectric liquid crystal panel, and liquid crystal screens having different display contents for every color are displayed in synchronization with the turning on of the backlight sources to achieve multicolor display.

### BACKGROUND OF THE INVENTION

1. Field of the Invention

The present invention relates to a small switch having a liquid crystal display capable of multi-color display on a liquid crystal panel for displaying information including characters and/or pictures.

2. Description of the Related Art

Push-button switches which are mounted on dispensers or the like and around which or on which the prices or names of articles are displayed to indicate the functions of the push-button switches are common. However, when the display is changed because of a change in price or name, the entire push-button switches must be replaced with new ones.

Accordingly, push-button switches including light-emitting diode displays or liquid crystal displays have been developed in order to realize various displays (for example, Japanese Examined Utility Model Registration Application Publication No. 7-22012 and Japanese Unexamined Patent Application Publication No. 10-223932).

Conventionally, monochrome liquid crystal displays have usually been used, as in calculators. In color liquid crystal displays, the entire liquid crystal panel has been switched to realize two-color display (red and yellow) by using backlights.

Typical super-twist nematic (STN) liquid crystals have problems with the visibility, including the viewing angle or the contrast, in some directions.

Furthermore, push-button switches capable of multicolor display are required in the market due to the increased functionality of electronic equipment.

When liquid crystal displays are applied to push-button switches, the prices or names of articles are generally displayed on the liquid crystal displays to indicate the functions of the switches.

However, in such cases, there are problems in that the luminance or hue of illuminants varies on the liquid crystal displays. For example, with a variation in the hue of illuminants, a user may not be able to recognize the display contents accurately or the user may select a wrong article due to his/her false recognition. At the same time, monochrome light emission has changed to multicolor light emission and, furthermore, full-color display has been increasingly adopted as the functionality of electronic equipment has increased. In such a situation, the presence of a variation in the luminance or hue of the electronic equipment is an important criterion for judgment of the quality of the electronic equipment. In order to reduce the variation in the luminance or hue, liquid crystal displays in which illuminants having different colors are arranged have been developed (refer to Japanese Unexamined Patent Application Publication No. 10-223932 mentioned above).

When multiple illuminants are turned on by time-sharing driving, there is a problem in that the luminance or hue of the individual illuminants varies, thus causing a user to falsely recognize the display contents.

### SUMMARY OF THE INVENTION

In order to solve the problems described above, it is an object of the present invention to provide an inexpensive small switch having a liquid crystal display having superior visibility owing to a wide viewing angle, rapid response, and a high contrast.

It is another object of the present invention to provide a small switch having a liquid crystal display capable of inhibiting a variation in the luminance or hue of individual illuminants to achieve uniform light emission when the liquid crystal display is continuously used.

The present invention provides, in its first aspect, a small switch having a liquid crystal display including an operation button; a liquid crystal display device having a liquid crystal panel for displaying information including characters and/or pictures on the operation button and a printed circuit board on which an integrated circuit (IC) chip, which serves as a driver circuit for the liquid crystal panel, is mounted, the liquid crystal display device being housed in the operation button; a switch body including a contact mechanism for opening and closing an electrical path by vertically moving the operation button; and backlight sources having different colors. The liquid crystal panel is an antiferroelectric liquid crystal panel. The backlight sources are sequentially turned on at high speed below the antiferroelectric liquid crystal panel, and liquid crystal screens having different display contents for every color are displayed in synchronization with the turning on of the backlight sources to achieve multicolor display.

The IC chip preferably includes a circuit for alternately applying bipolar voltages and a circuit for generating a reset signal that resets the applied voltage to 0 V when the small switch is turned off to turn off the liquid crystal display.

Hence, it is possible to realize an inexpensive small switch having a liquid crystal display having superior visibility owing to a wide viewing angle, rapid response, and a high contrast and capable of preventing burn-in of the liquid crystal display.

The present invention provides, in its second aspect, a small switch having a liquid crystal display including an operation button; a liquid crystal display device having a liquid crystal panel for displaying information including characters and/or pictures on the operation button and a printed circuit board on which an IC chip, which serves as a driver circuit for the liquid crystal panel, is mounted, the liquid crystal display device being housed in the operation button; a switch body including a contact mechanism for opening and closing an electrical path by vertically moving the operation button; and backlight sources having different colors. The liquid crystal panel is an antiferroelectric liquid crystal panel. The backlight sources are sequentially turned on at high speed below the antiferroelectric liquid crystal panel, and setting of segment electrodes and scanning of common electrodes are sequentially performed for each color for every common electrode, which are scanning lines, in synchronization with the turning on of the backlight sources to achieve multicolor display. The IC chip includes a circuit for alternately applying bipolar voltages and a circuit for generating a reset signal that resets the applied voltage to 0 V when the small switch is turned off to turn off the liquid crystal display.

The IC chip preferably further includes a circuit for sequentially scanning the scanning lines and generating the reset signal at an arbitrary timing.

Hence, it is possible to realize an inexpensive small switch having a liquid crystal display having superior visibility owing to a wide viewing angle, rapid response, and a high contrast and capable of preventing burn-in of the liquid crystal display. Particularly, this structure is more effective for still pictures.

The present invention provides, in its third aspect, a small switch having a liquid crystal display including a liquid crystal panel for displaying information including characters and/or pictures on the main body of the small switch; a printed circuit board on which an IC chip, which serves as a driver circuit for the liquid crystal panel, is mounted; and a holder having illuminants having different colors provided thereon, the holder being provided below the liquid crystal panel. The IC chip includes a circuit for controlling a current and a voltage to be supplied to the illuminants, a lighting control circuit for performing time-sharing control for the illuminants, and a current-voltage adjusting circuit for correcting a variation in the luminance or hue of the illuminants.

Hence, it is possible to realize an a small switch having a liquid crystal display capable of inhibiting a variation in the luminance or hue of individual illuminants to achieve uniform light emission even when multiple liquid crystal displays are used close to each other.

The liquid crystal panel is preferably an antiferroelectric liquid crystal panel.

The small switch having a liquid crystal display may further include an operation button beneath which the liquid crystal panel is provided and which houses the printed circuit board having the IC chip, which serves as the driver circuit for the liquid crystal panel, mounted thereon. The small switch may be a push-button switch having a switch body including a contact mechanism for opening and closing an electrical path by vertically moving the operation button.

With the small switch having a liquid crystal display described above, there is no need to provide a current limiting resistance for every illuminant for adjusting the luminance or hue of the illuminants and uniform light emission can be achieved. Furthermore, it is possible to inhibit a visual variation without selecting the illuminants based on the luminance, forward voltage, or the like.

### BRIEF DESCRIPTION OF THE DRAWINGS

FIG. 1 is a cross-sectional view of main parts of a push-button switch having a liquid crystal display according to an embodiment of the present invention;

FIG. 2 is an exploded perspective view of the push-button switch having a liquid crystal display;

FIG. 3 illustrates how a liquid crystal panel in the push-button switch having a liquid crystal display is driven according to an embodiment of the present invention;

FIG. 4 is a block diagram showing the circuit configuration of the push-button switch having a liquid crystal display according to an embodiment of the present invention;

FIG. 5 illustrates applied voltage to an antiferroelectric liquid crystal panel and a variation in light transmittance with respect to the applied voltage according to an embodiment of the present invention; and

FIG. 6 is a block diagram showing the circuit configuration of a liquid crystal display for a small switch according to an embodiment of the present invention.

### DESCRIPTION OF THE PREFERRED EMBODIMENTS

In order to realize an inexpensive small switch having a liquid crystal display having superior visibility owing to a wide viewing angle, rapid response, and a high contrast and capable of preventing burn-in of the liquid crystal display, the liquid crystal panel is an antiferroelectric liquid crystal panel, the backlight sources having different colors are sequentially turned on at high speed below the antiferroelectric liquid crystal panel, and liquid crystal screens having different display contents for every color are displayed in synchronization with the turning on of the backlight sources to achieve multicolor display. In addition, the IC chip includes a circuit for alternately applying bipolar voltages and a circuit for generating a reset signal that resets the applied voltage to 0 V when the small switch is turned off to turn off the liquid crystal display.

In order to realize an inexpensive small switch having a liquid crystal display having superior visibility owing to a wide viewing angle, rapid response, and a high contrast and capable of preventing burn-in of the liquid crystal display, the liquid crystal panel is an antiferroelectric liquid crystal panel, the backlight sources having different colors are sequentially turned on at high speed below the antiferroelectric liquid crystal panel, and setting of segment electrodes and scanning of common electrodes are sequentially performed for each color for every common electrode, which are scanning lines, in synchronization with the turning on of the backlight sources to achieve multicolor display. In addition, the IC chip includes a circuit for alternately applying bipolar voltages, a circuit for generating a reset signal that resets the applied voltage to 0 V when the small switch is turned off to turn off the liquid crystal display, and a circuit for sequentially scanning the scanning lines and generating the reset signal at an arbitrary timing.

Furthermore, in order to inhibit a variation in the luminance or hue of individual illuminants, serving as the backlight sources, to achieve uniform light emission, according to the small switch having a liquid crystal display of the present invention, the IC chip stores current-and-voltage setting data used as a reference of the brightness of the illuminants, and includes a lighting control circuit for performing time-sharing control of the illuminants and a current-voltage adjusting circuit for correcting a variation in the luminance or hue of the illuminants.

### EMBODIMENTS

Embodiments of the present invention will be described below with reference to the attached drawings.

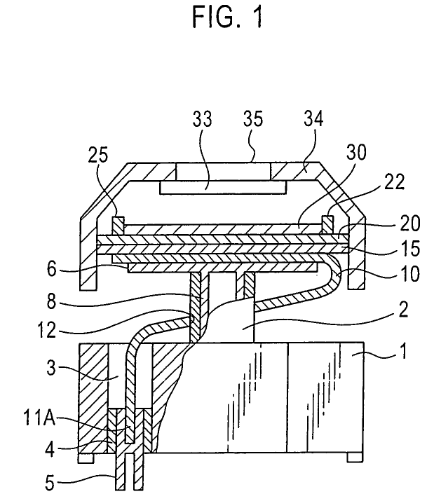

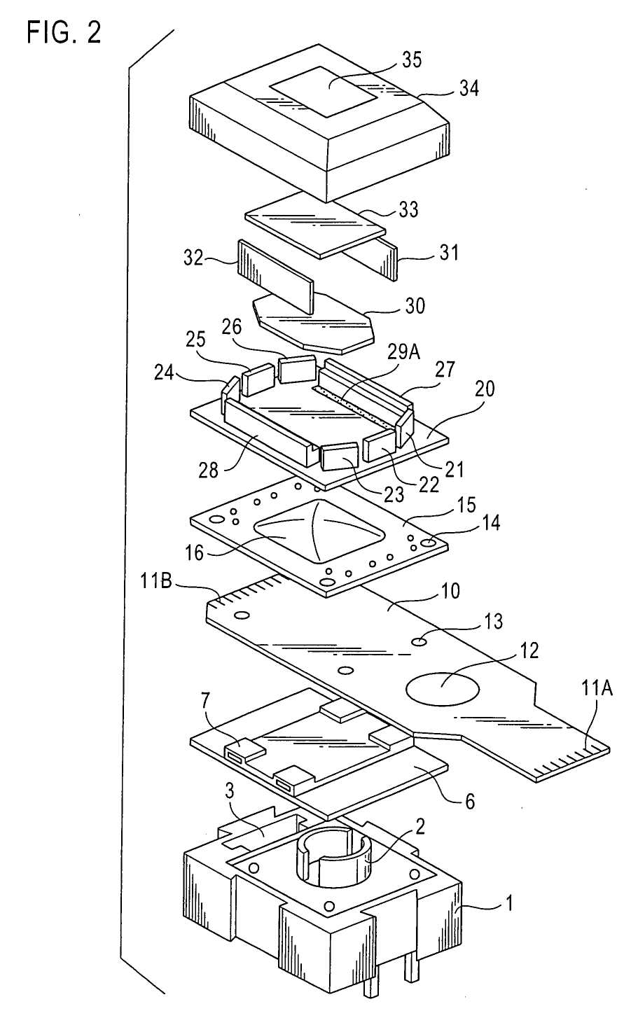

FIG. 1 is a cross-sectional view of main parts of a push-button switch having a liquid crystal display according to an embodiment of the present invention. FIG. 2 is an exploded perspective view of the push-button switch having a liquid crystal display in FIG. 1.

Referring to FIGS. 1 and 2, an operating shaft 2 is mounted in the central part of a switch body 1. A concavity 3 is formed at the left side of the switch body 1. A connector 4 with switch terminals 5 is provided below the concavity 3. A circuit pattern 11A at one end of a flexible printed wiring board 10 described below is connected to the connector 4.

The flexible printed wiring board 10 has a through-hole 12 formed therein, through which the operating shaft 2 passes. The flexible printed wiring board 10 has the circuit pattern 11A and a circuit pattern 11B at opposing ends, and also has mounting holes 13 by which a printed circuit board 15 and a holder 20 are mounted and fixed. A plunger 6 having projections 7 at opposing ends is provided at the top edge of the operating shaft 2. The flexible printed wiring board 10 is attached to the projections 7. The circuit pattern 11B at the other end of the flexible printed wiring board 10 is connected and fixed on the rear face of the printed circuit board 15. An integrated circuit (IC) chip 16, described below, is mounted on the printed circuit board 15. The holder 20 is provided on the printed circuit board 15. Projections (not shown) beneath the holder 20 pass through through-holes 14 in the printed circuit board 15 and the mounting holes 13 for mounting and fixing in the flexible printed wiring board 10 to fix the holder 20 and the printed circuit board 15 on the flexible printed wiring board 10. A set of light-emitting diodes 21, 22, and 23 and a set of light-emitting diodes 24, 25, and 26 having multiple colors (red, green, blue, and so on) are provided on the holder 20. The light-emitting diodes 21 to 26 are connected and fixed on the circuit pattern on the printed circuit board 15. The light-emitting diodes may be integrated with each other so as to have multiple colors.

On opposing sides where the light-emitting diodes 21 to 26 are not provided on the holder 20, protrusions 27 and 28 are formed. A long hole 29A is formed inside the protrusion 27 and a long hole 29B (not shown) is formed inside the protrusion 28. ZEBRA connectors 31 and 32 are mounted on the circuit pattern on the printed circuit board 15 through the long holes 29A and 29B, respectively. An antiferroelectric liquid crystal panel 33 is provided on the ZEBRA connectors 31 and 32. A diffuser 30 is provided in a void between the light-emitting diodes 21 to 26, which are opposed to each other on the holder 20, inside the ZEBRA connectors 31 and 32. An operation button 34 is provided so as to cover the assembly including the components described above. A display 35 made of a translucent material is formed in the center of the operation button 34.

The plunger 6 is elastically fitted into the space inside the operation button 34. The components from the antiferroelectric liquid crystal panel 33 to the plunger 6 are housed in the operation button 34.

The switch body 1 has a switch mechanism. The operating shaft 2 for driving the switch mechanism is protruded from the switch body 1.

A shaft 8 protruding downward below the plunger 6 is connected to the operating shaft 2 so as to transmit the operating force. The flexible printed wiring board 10 is folded at one end of the plunger 6 and the operating shaft 2 passes through the through-hole 12 in the flexible printed wiring board 10. The circuit pattern 11A at one end of the flexible printed wiring board 10 is connected to the connector 4 with the switch terminals 5.

In the structure described above, power is supplied from the switch terminals 5 of the connector 4 with the switch terminals 5 to the printed circuit board 15 through the flexible printed wiring board 10. The power is supplied to the light-emitting diodes 21 to 26 and the antiferroelectric liquid crystal panel 33 through the IC chip 16. The IC chip 16 controls driving of the light-emitting diodes 21 to 26 and the antiferroelectric liquid crystal panel 33 to display various characters and/or pictures and to vary the hue.

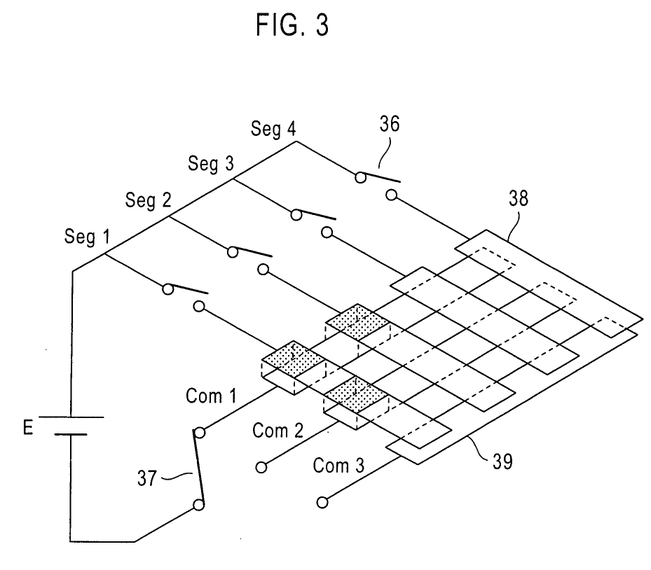

FIG. 3 illustrates how the liquid crystal panel in the push-button switch having a liquid crystal display is driven according to an embodiment of the present invention.

Referring to FIG. 3, liquid crystals are produced by filling a space between two sheets of glass having polarizing plates with a liquid crystal substance. Applying a voltage between opposing electrodes 38 and 39 on the two sheets of glass, that is, an upper sheet of glass and a lower sheet of glass, actuates only some of the liquid crystals to which the voltage is applied. Such liquid crystals look black in a monochrome liquid crystal display. Common electrodes Com1 to ComN are laterally provided on the lower sheet of glass in the shape of the teeth of a comb. Segment electrode Seg1 to SegM are longitudinally provided on the upper sheet of glass in the shape of the teeth of a comb. Areas where the common electrodes Com1 to ComN intersect with the segment electrodes Seg1 to SegM are referred to as dots.

In order to drive the liquid crystal panel, segment-electrode setting switches 36 are operated to turn on pixels to be displayed. First, a common-electrode scanning switch 37 is switched to turn on the common electrode Com1. Turning on the segment-electrode setting switches 36 applies voltage to the dots where the common electrode Com1 intersects with the corresponding segment electrodes and provides a display in accordance with the setting of the segment-electrode setting switches 36. Next, in preparation for turning on the dots on the common electrode Com2, the segment-electrode setting switches 36 are turned off and the common-electrode scanning switch 37 is switched to the common electrode Com2. The segment-electrode setting switches 36 are used to set the display contents of the common electrode Com2. The display contents set by using the segment-electrode setting switches 36 are displayed in the lateral line of the common electrode Com2. The setting of the segment electrodes and the scanning of the common electrodes are sequentially performed for the common electrodes Com3, Com4, . . . , Com(N−1), and ComN.

For example, when the liquid crystal panel has 36 segment-electrode setting switches 36 and 24 common electrodes, it is necessary to scan at a speed higher than 60 Hz in order to perform the scanning of the common electrodes Com1 to Com24 without flicker. Accordingly, one screen including the common electrodes Com1 to Com24 is scanned at a speed higher than 1/60 sec=17 ms. The time period required for scanning one screen is called the frame period.

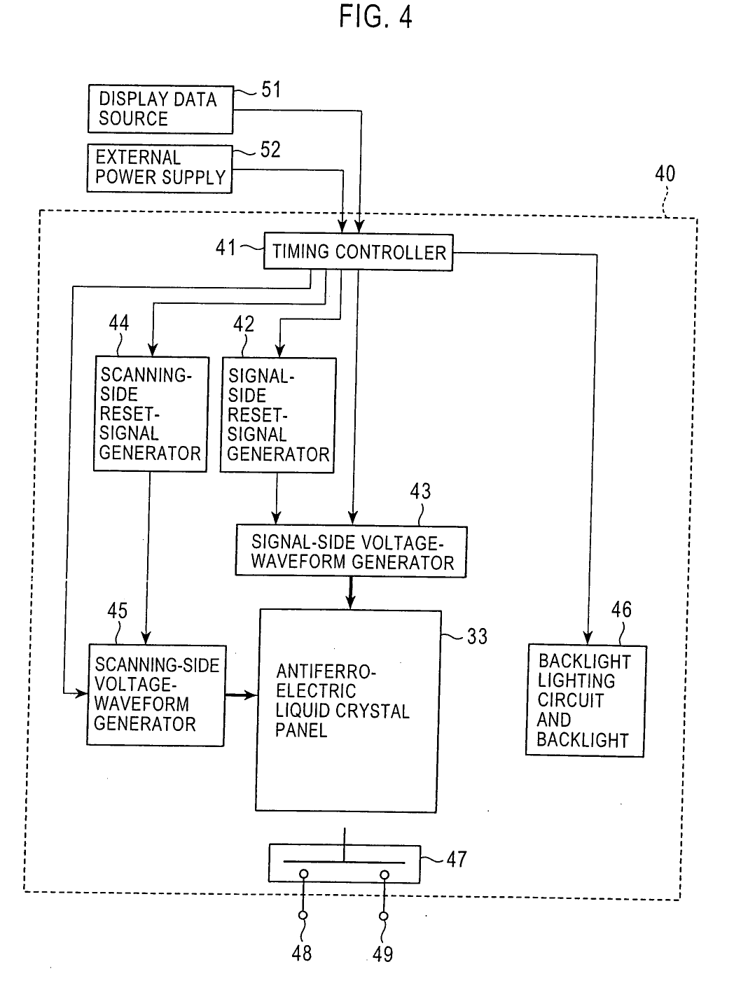

FIG. 4 is a block diagram showing the circuit configuration of the push-button switch having a liquid crystal display according to an embodiment of the present invention.

Referring to FIG. 4, the circuit 40 of the push-button switch having a liquid crystal display has the IC chip 16 including a timing controller 41, a signal-side voltage-waveform generator 43, a scanning-side voltage-waveform generator 45, a backlight lighting circuit and backlight 46, a signal-side reset-signal generator 42, described below, and a scanning-side reset-signal generator 44, described below, in order to drive the antiferroelectric liquid crystal panel 33 provided beneath the upper face of the operation button 34. Referring to FIG. 4, reference numeral 47 denotes a switch mechanism, reference numerals 48 and 49 denote switch terminals, reference numeral 51 denotes a display data source, and reference numeral 52 denotes an external power supply.

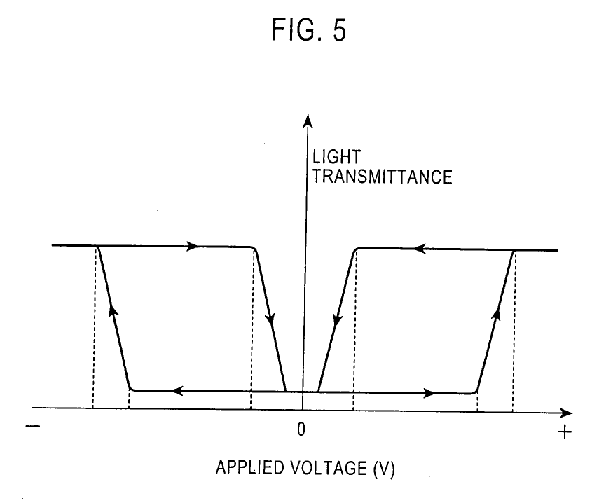

FIG. 5 illustrates applied voltage to the antiferroelectric liquid crystal panel 33 and a variation in light transmittance with respect to the applied voltage according to an embodiment of the present invention. Antiferroelectric liquid crystals in the antiferroelectric liquid crystal panel 33 exhibit a sequential response in which liquid crystal molecules are completely inverted in one writing, so that they can operate at high speed, and they are more inexpensive than thin-film transistor (TFT) liquid crystals. In a high-speed operation, one screen must be displayed at a speed higher than 60 Hz and the display speed of one screen is 60 Hz×3=180 Hz. That is, the operation speed of liquid crystals must be 5.6 ms or less per screen.

Referring to FIG. 5, the horizontal axis represents applied voltage and the vertical axis represents relative light transmittance. Liquid crystal cells are in a dark state at an applied voltage of 0 V. Hence, when the applied voltage is increased in the positive direction, the arrangement of the liquid crystal molecules starts to vary and the liquid crystal cells change to a bright state along with an increase in the applied voltage. That is, the liquid crystal cells change from the dark state to the bright state as the applied voltage is increased. When the applied voltage is varied in the negative direction, they change from the dark state to the bright state, as in the positive direction. According to the present invention, the bipolar voltages in the positive direction and the negative direction are alternately applied to the liquid crystal cells.

In the push-button switch having a liquid crystal display of the present invention, the antiferroelectric liquid crystal panel 33 is provided on the rear face of the display 35 in the center of the operation button 34, and the light-emitting diodes 21 to 26, which are separate backlight sources having different colors, are sequentially turned on at high speed. In synchronization with the turning on of the light-emitting diodes, different display contents are displayed for every color in the display 35 (liquid crystal screen) to achieve multicolor display owing to the persistence of vision. In addition, in synchronization with the turning on of the light-emitting diodes, the setting of the segment electrodes and the scanning of the common electrodes are sequentially performed for each color for every common electrode Com1 to ComN, which are the scanning lines, in order to achieve multicolor display owing to the persistence of vision.

When the antiferroelectric liquid crystal panel 33 is turned off in a state in which characters and/or pictures are displayed in the antiferroelectric liquid crystal panel 33 to turn off the liquid crystal display, the liquid crystal display is turned off in a state in which the voltage is applied, and the liquid crystal panel exhibits burn-in if it has not been used for a long period. Furthermore, when the antiferroelectric liquid crystal panel 33 continues to display characters and/or pictures, the liquid crystal panel is used in the state in which the voltage is applied. If the liquid crystal panel has been used in this state for a long period, the liquid crystal panel exhibits burn-in, thus disadvantageously providing unclear display. According to the present invention, in order to solve the problems described above, the signal-side reset-signal generator 42 for sequentially scanning the scanning lines and generating a reset signal at an arbitrary timing and the scanning-side reset-signal generator 44 are provided in the IC chip 16. As a result, when the antiferroelectric liquid crystal panel 33 is turned off to turn off the liquid crystal display, the liquid crystal cells can be changed to the dark state at an applied voltage of 0 V and, therefore, the liquid crystal display is not turned off in the state in which the voltage is applied. Even when the liquid crystal panel has been used in the off state for a long period, it is possible to prevent the liquid crystal panel from exhibiting burn-in. In addition, even when still pictures have been displayed for a long period, the state in which the voltage is applied is released at an arbitrary timing, thus preventing the liquid crystal panel from exhibiting burn-in.

With the push-button switch having a liquid crystal display having the structure described above, it is possible to achieve multicolor display by using an antiferroelectric liquid crystal panel capable of simultaneously realizing wide viewing angle, rapid response, and high contrast, sequentially turning on the backlight sources having different colors at high speed below the antiferroelectric liquid crystal panel, and displaying the liquid crystal screens having different display contents for every color in synchronization with the turning on of the backlight sources. Furthermore, in synchronization with the turning on of the backlight sources, the setting of the segment electrodes and the scanning of the common electrodes are sequentially performed for each color for every common electrode Com1 to ComN, which are the scanning lines, in order to achieve the multicolor display. The IC chip in the push-button switch having a liquid crystal display includes a circuit for alternately applying the bipolar voltages and a circuit for generating the reset signal that resets the applied voltage to 0 V when the liquid crystal panel is turned off to turn off the liquid crystal display.

Incorporating the circuit for sequentially scanning the scanning lines and generating the reset signal at an arbitrary timing in the IC chip can prevent burn-in of the liquid crystal panel occurring in the state in which the voltage is applied, thus realizing an inexpensive push-button switch having a liquid crystal display having superior visibility owing to a wide viewing angle, rapid response, and a high contrast.

A small switch having a liquid crystal display capable of inhibiting a variation in the luminance or hue of individual illuminants to achieve uniform light emission when the liquid crystal display is consecutively used will now be described.

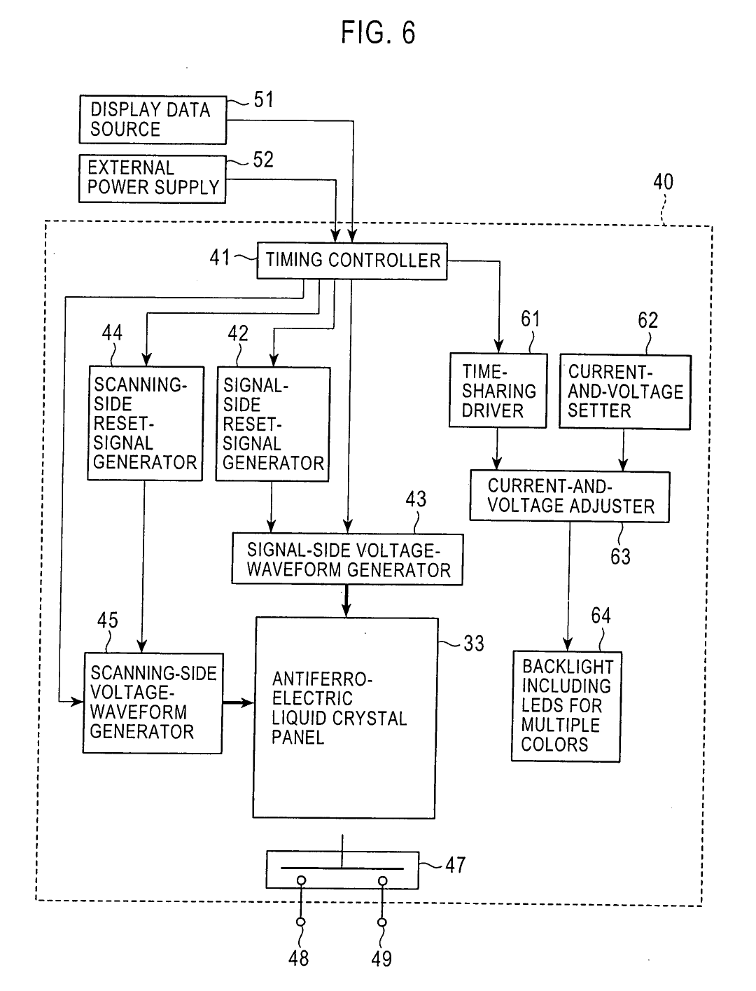

FIG. 6 is a block diagram showing the circuit configuration of a liquid crystal display for a small switch according to an embodiment of the present invention.

Referring to FIG. 6, the circuit 40 of the liquid crystal display for a small switch includes a backlight 64 including light-emitting diodes (LEDs) for multiple colors provided in the operation button 34, a current-and-voltage setter 62 for storing in advance current-and-voltage setting data used as a reference of the brightness of the illuminants to drive the backlight 64, the timing controller 41, a time-sharing driver 61, and a current-and-voltage adjuster 63. Specifically, a voltage that is subjected to time-sharing in the time-sharing driver 61 is applied to the backlight 64 to control lighting of the backlight 64, and power that is adjusted so as to have appropriate current-and-voltage in the current-and-voltage adjuster 63 based on the current-and-voltage setting data stored in the current-and-voltage setter 62 is supplied to the backlight 64. Hence, it is possible to correct a variation in the luminance or hue of the illuminant and to achieve uniform light emission.

The circuit 40 of the liquid crystal display for a small switch further includes a driver circuit for the antiferroelectric liquid crystal panel 33 provided beneath the upper surface of the operation button 34. Namely, the circuit 40 includes the signal-side reset-signal generator 42, the signal-side voltage-waveform generator 43, the scanning-side reset-signal generator 44, and the scanning-side voltage-waveform generator 45 in order to drive the antiferroelectric liquid crystal panel 33.

The circuit 40 further has the switch mechanism 47 and the switch terminals 48 and 49. The display data source 51 and the external power supply 52 are connected to the timing controller 41 in the circuit 40.

The structure of the push-button switch is the same as in FIGS. 1 and 2. A description of the structure is omitted here.

The operation of the push button may be applied to a small switch for slide conversion or rotary conversion.

Although the illuminants for multiple colors are provided at the opposing sides of the holder below the liquid crystal panel in the above embodiment, the position of the illuminants is not limited to there. The illuminants may be provided at an arbitrary position on the holder below the liquid crystal panel as long as clear display is realized.

It will be further understood by those skilled in the art that the foregoing description is of the preferred embodiments of the present invention and that various changes and modifications may be made to the invention without departing from the spirit and scope thereof.

The small switch having a liquid crystal display according to the present invention is suitable for a push-button switch having a liquid crystal display capable of preventing burn-in of the liquid crystal panel for displaying information including characters and/or pictures and capable of multicolor display.

It is possible to combine the switch with indicators. The switch can be freely combined with indicators for various applications.

The present invention is preferably applied to a small switch having a liquid crystal display capable of inhibiting a variation in the luminance or hue of individual illuminants to achieve uniform light emission.

1-4. (canceled)

5. A small switch having a liquid crystal display, the small switch comprising:
a liquid crystal panel for displaying information including characters and/or pictures on the main body of the small switch;
a printed circuit board on which an IC chip, which serves as a driver circuit for the liquid crystal panel, is mounted; and
a holder having illuminants having different colors provided thereon, the holder being provided below the liquid crystal panel,
wherein the IC chip includes a circuit for controlling a current and a voltage to be supplied to the illuminants, a lighting control circuit for performing time-sharing control of the illuminants, and a current-voltage adjusting circuit for correcting a variation in the luminance or hue of the illuminants.

6. The small switch having a liquid crystal display according to claim 5,
wherein the liquid crystal panel is an antiferroelectric liquid crystal panel.

7. The small switch having a liquid crystal display according to claim 5, further comprising:
an operation button beneath which the liquid crystal panel is provided and which houses the printed circuit board having the IC chip, which serves as the driver circuit for the liquid crystal panel, mounted thereon,
wherein the small switch is a push-button switch having a switch body including a contact mechanism for opening and closing an electrical path by vertically moving the operation button.
